(19) United States
(12) Patent Application Publication
(10) Pub. No.: US 2026/0121518 A1
(43) Pub. Date: Apr. 30, 2026

(54) POWER CONVERSION APPARATUS

(71) Applicant: TOYOTA JIDOSHA KABUSHIKI KAISHA, Toyota-shi (JP)

(72) Inventor: Hirotsugu OHATA, Susono-shi (JP)

(73) Assignee: TOYOTA JIDOSHA KABUSHIKI KAISHA, Toyota-shi (JP)

(21) Appl. No.: 19/328,798

(22) Filed: Sep. 15, 2025

(30) Foreign Application Priority Data
Oct. 30, 2024 (JP) 2024-190822

(51) Int. Cl. H02M 1/32; H02M 7/49

(52) U.S. Cl. CPC H02M 1/327; H02M 7/49

(57) ABSTRACT

A power conversion apparatus connected to a power storage device and a motor having a three-phase open winding includes: a first inverter connected to a power line to which the power storage device is connected, and connected to a first end side of the three-phase open winding; a second inverter connected to the power line, and connected to a second end side of the three-phase open winding; and a control device that generates PWM signals of a plurality of switching elements of the first and second inverters by using a modulated wave and a carrier wave of each phase, and controls the first and second inverters. The control device varies a carrier frequency of the carrier wave for each phase of each of the first and second inverters based on a variation in an element temperature of each of the switching elements of the first and second inverters.

### CROSS-REFERENCE TO RELATED APPLICATION

This application claims priority to Japanese Patent Application No. 2024-190822 filed on Oct. 30, 2024. The disclosure of the above-identified application, including the specification, drawings, and claims, is incorporated by reference herein in its entirety.

### BACKGROUND

### 1. Technical Field

The present disclosure relates to a power conversion apparatus.

### 2. Description of Related Art

A power conversion apparatus including a first inverter that converts direct-current power from a first power source into alternating-current power, a second inverter that converts direct-current power from a second power source into alternating-current power, and a motor driven by alternating-current power from the first and the second inverters has been proposed (see Japanese Unexamined Patent Application Publication No. 2019-170042 (JP 2019-170042 A)). In the power conversion apparatus, switching signals for driving the first and second inverters are generated based on comparison between modulated waves respectively indicating first and second voltage commands and first and second carrier waves. In this case, first and second carrier frequencies that are frequencies of the first and second carrier waves are set to be different from each other based on an operating point of the motor.

### SUMMARY

In such a power conversion apparatus, element temperatures of switching elements of each phase of the first and second inverters may vary. When solely the element temperatures of a specific switching element of the first or second inverter is excessively high, an output of a motor may be limited in order to protect components.

A main object of the power conversion apparatus according to the present disclosure is to restrain the element temperature of the specific switching element of the first or second inverter from being excessively high.

In order to achieve the above-described main object, the power conversion apparatus according to the present disclosure is configured as follows.

A power conversion apparatus according to the present disclosure is a power conversion apparatus connected to a power storage device and a motor having a three-phase open winding. The power conversion apparatus includes:
a first inverter connected to a power line to which the power storage device is connected, and connected to a first end side of the three-phase open winding;
a second inverter connected to the power line, and connected to a second end side of the three-phase open winding; and
a control device configured to generate PWM signals of a plurality of switching elements of the first and second inverters by using a modulated wave and a carrier wave of each phase, and to control the first and second inverters, the modulated wave being based on a torque command of the motor.
   The control device is configured to vary a carrier frequency of the carrier wave for each phase of the first and second inverters based on a variation in an element temperature of each of the switching elements of the first and second inverters.

In the power conversion apparatus according to the present disclosure, the carrier frequency of the carrier wave is varied for each phase of the first and second inverters based on the variation in the element temperature of each of the switching elements of the first and second inverters. As a result, it is possible to restrain the element temperature of the specific switching element of the first and second inverters from being excessively high.

In the power conversion apparatus according to the present disclosure, the control device may be configured to set the carrier frequency for each phase of the first and second inverters such that the carrier frequency is lower as the element temperature is higher.

In the power conversion apparatus according to the present disclosure, the control device may be configured to, in a case where the motor is in a lock state, lower the carrier frequency of a current concentration phase based on an electrical angle of the motor as compared to a case where the motor is not in the lock state.

In the power conversion apparatus according to the present disclosure, the control device may be configured to set the carrier frequency for each phase of the first and second inverters such that the carrier frequency is lower as an integrated value of an absolute value of a phase current in a predetermined time is larger.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle including a power conversion apparatus according to an embodiment of the present disclosure;

FIG. 2 is a block diagram showing an example of a functional block in the control of the first and second inverters 22, 24 by the ECU; and

FIG. 3 is an explanatory diagram showing an example of a carrier frequency setting map.

### DETAILED DESCRIPTION OF EMBODIMENTS

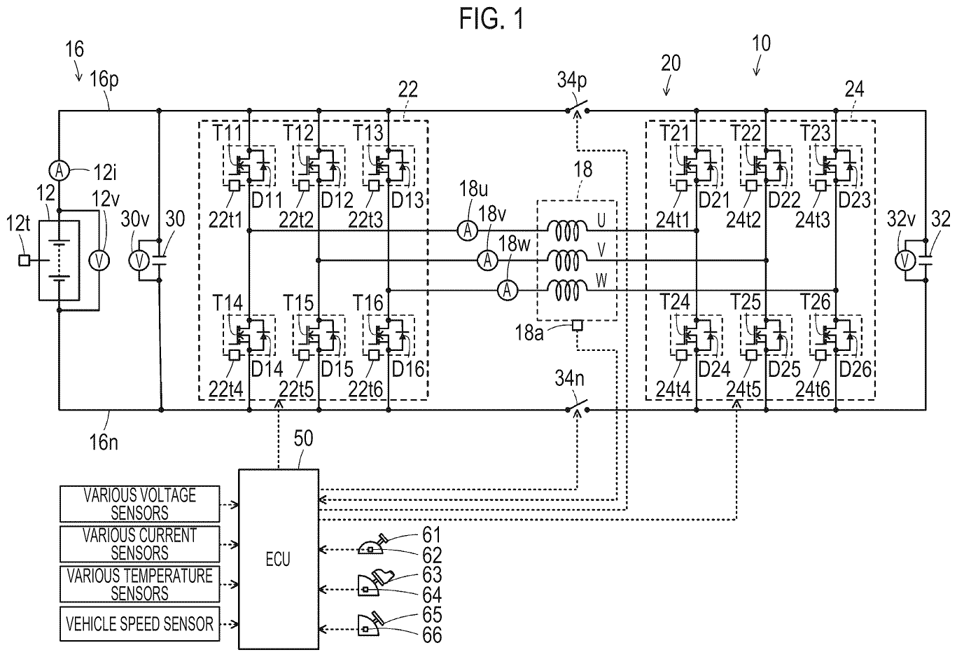

An embodiment for carrying out the present disclosure will be described with reference to the drawings. FIG. 1 is a schematic configuration diagram of a battery electric vehicle 10 including a power conversion apparatus 20 of an embodiment of the present disclosure. The battery electric vehicle 10 of the embodiment includes a battery 12 as a power storage device and a motor 18, as illustrated. In addition, as illustrated, the battery electric vehicle 10 of the embodiment includes a power conversion apparatus 20 and an electronic control unit (hereinafter, referred to as “ECU”) 50 as a control device.

The battery 12 is configured as, for example, a lithium ion secondary battery or a nickel-hydrogen secondary battery, and is connected to the power line 16 (positive electrode side line 16p and negative electrode side line 16n). The motor 18 is configured as a three-phase alternating current motor, and includes a rotor in which a permanent magnet is embedded in a rotor core and a stator in which three-phase (U-phase, V-phase, W-phase) coils (three-phase open winding) are wound around a stator core. The rotor is connected to a drive shaft connected to drive wheels via a differential gear.

The power conversion apparatus 20 includes first and second inverters 22, 24, first and second capacitors 30, 32, and switching switches 34p, 34n. The first and second inverters 22, 24 each include six transistors T11 to T16, T21 to T26 as switching elements. In addition, the first and second inverters 22, 24 each include six diodes D11 to D16, D21 to D26 connected in parallel to each of six transistors T11 to T16, T21 to T26, respectively. As the transistors T11 to T16, T21 to T26, for example, a MOSFET or an IGBT is used. The transistors T11 to T16, T21 to T26 are disposed in pairs such that the transistors T11 to T16, T21 to T26 are source sides and sink sides with respect to the positive electrode side line 16p and the negative electrode side line 16n. Each of connection points of two transistors corresponding to the transistors T11 to T16 is connected to each of one-end sides of the three-phase coils of the motor 18. Each of connection points of two transistors corresponding to the transistors T21 to T26 is connected to each of the other ends of the three-phase coils of the motor 18. Hereinafter, the transistors T11 to T13 may be referred to as a “first upper arm”, the transistors T14 to T16 may be referred to as a “first lower arm”, the transistors T21 to T23 may be referred to as a “second upper arm”, and the transistors T24 to T26 may be referred to as a “second lower arm”.

The first and second capacitors 30, 32 are connected to the first and second inverters 22, 24 in the power line 16, respectively. In the embodiment, the battery 12, the first capacitor 30, the first inverter 22, the second inverter 24, and the second inverter 24 are connected to the power line 16 in this order from the left side of FIG. 1. The switching switches 34p, 34n are provided between the first and second inverters 22, 24 of the positive electrode side line 16p and the negative electrode side line 16n, respectively. As the switching switches 34p, 34n, for example, a semiconductor switch or an insulation type switch is used.

The ECU 50 includes a microcomputer having a CPU, a ROM, a RAM, a flash memory, an input/output port, and a communication port, or various drive circuits and various logic ICs. The ECU 50 receives signals from various sensors. For example, the ECU 50 receives the voltage Vb of the battery 12 from the voltage sensor 12v, the current Ib of the battery 12 from the current sensor 12i, and the temperature ab of the battery 12 from the temperature sensor 12t. The ECU 50 also receives a rotation position θm of the rotor of the motor 18 from the rotation position sensor 18a, and phase currents Iu, Iv, Iw of the motor 18 from the current sensors 18u, 18v, 18w. The temperatures αi11 to αi16, αi21 to αi26 of the transistors T11 to T16, T21 to T26 from the temperature sensors 22t1 to 22t6, 24t1 to 24t6 are also input to the ECU 50. The ECU 50 also receives a voltage VH of the first capacitor 30 from the voltage sensor 30v and a voltage VL of the second capacitor 32 from the voltage sensor 32v. The ECU 50 also receives an on/off signal from the power switch, a shift position SP that is the operation position of the shift lever 61 from the shift position sensor 62, and an accelerator operation amount Acc that is the depression amount of the accelerator pedal 63 from the accelerator pedal position sensor 64. The ECU 50 also receives a brake pedal position BP that is a depression amount of the brake pedal 65 from a brake pedal position sensor 66 and a vehicle speed V from a vehicle speed sensor 67.

The ECU 50 outputs various control signals. For example, the ECU 50 outputs control signals to the transistors T11 to T16 of the first inverter 22, the transistors T21 to T26 of the second inverter 24, and the switching switches 34p, 34n. The ECU 50 calculates the electric power storage ratio SOC of the battery 12 based on the integrated value of the current Ib of the battery 12. The ECU 50 calculates the electrical angle de of the motor 18 and the rotation speed Nm based on the rotation position Om of the rotor of the motor 18. The ECU 50 transforms the phase currents Iu, Iv, and Iw of each phase into the d-axis current Id and the q-axis current Iq by using the electrical angle θe of the motor 18 (3-phase to 2-phase transformation).

In the battery electric vehicle 10 of the embodiment, the ECU 50 sets the request torque Td* requested for traveling based on the accelerator operation amount Acc and the vehicle speed V. Then, the ECU 50 sets the torque command Tm* of the motor 18 such that the vehicle travels with the set request torque Td*. Basically, the first and second inverters 22, 24 are controlled such that the switching switches 34p, 34n are in the on state and the motor 18 is driven by the torque command Tm*.

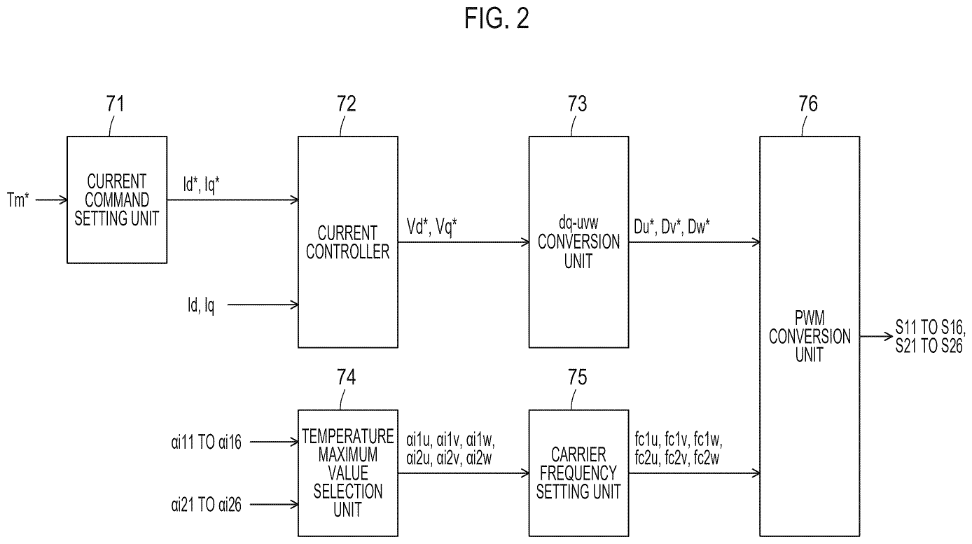

Next, the operation of the battery electric vehicle 10 of the embodiment, particularly, the control of the first and second inverters 22, 24 will be described. FIG. 2 is a block diagram showing an example of a functional block in the control of the first and second inverters 22, 24 by the ECU 50. As shown in the drawings, the ECU 50 includes hardware, such as a CPU. The ECU 50 includes a current command setting unit 71 and a current controller 72 as functional blocks in cooperation with a plurality of programs (software) installed in a ROM or a flash memory. The ECU 50 includes a dq-uvw conversion unit 73, a temperature maximum value selection unit 74, a carrier frequency setting unit 75, and a PWM conversion unit 76 as the function blocks.

The current command setting unit 71 sets the current commands Id*, Iq* of the d-axis, q-axis based on the torque command Tm* of the motor 18. For example, the torque command Tm* is applied to a current command map that is determined in advance by an experiment, analysis, or the like as a relationship between the torque command Tm* and the current commands Id*, Iq* of the d-axis and the q-axis. The current command setting unit 71 derives and sets the corresponding d-axis and q-axis current commands Id*, Iq* from the current command map.

The current controller 72 calculates d-axis and q-axis voltage commands Vd*, Vq* by current feedback control such that the difference between the d-axis and q-axis currents Id, Iq and the d-axis and q-axis current commands Id*, Iq* from the current command setting unit 71 is canceled.

The dq-uvw conversion unit 73 converts the voltage commands Vd*, Vq* of the d-axis and the q-axis from the current controller 72 into the phase voltage commands Vu*, Vv*, and Vw* of the respective phases by using the electrical angle de of the motor 18 (two-phase to three-phase conversion). The dq-uvw conversion unit 73 further divides the phase voltage commands Vu*, Vv*, and Vw* of each phase by the voltage VH of the first capacitor 30 (power line 16) to calculate the duty commands Du*, Dv*, and Dw* (modulated wave) of each phase.

The temperature maximum value selection unit 74 sets the element temperatures αi1u, αi1v, αi1w, αi2u, αi2v, αi2w of each phase of each of the first and second inverters 22, 24. This setting is performed based on the temperatures αi11 to αi16, αi21 to αi26 of the transistors T11 to T16, T21 to T26 of the first and second inverters 22, 24. Specifically, the maximum values of the temperatures αi11, αi14 of the transistors T11, T14 are set to the element temperature αi1u of the U phase of the first inverter 22. The maximum values of the temperatures αi12, αi15 of the transistors T12, T15 are set to the element temperature αi1v of the first inverter 22 of the V phase. The maximum values of the temperatures αi13, αi16 of the transistors T13, T16 are set to the element temperature αi1w of the W phase of the first inverter 22. The maximum values of the temperatures αi21, αi24 of the transistors T21, T24 are set to the element temperature αi2u of the U-phase of the second inverter 24. The maximum values of the temperatures αi22, αi25 of the transistors T22, T25 are set to the element temperature αi2v of the second inverter 24 of the V phase. The maximum values of the temperatures αi23, αi26 of the transistors T23, T26 are set to the element temperature αi2w of the W phase of the second inverter 24.

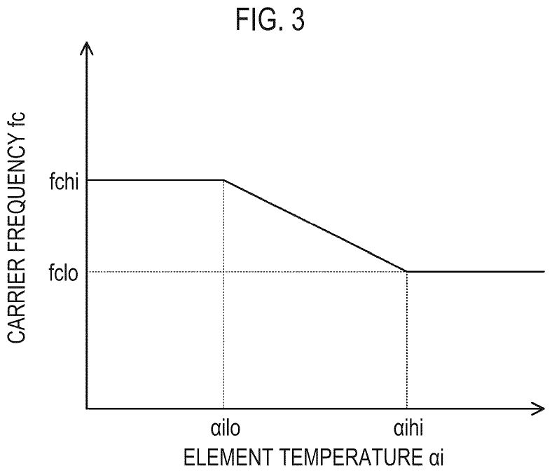

The carrier frequency setting unit 75 sets the carrier frequencies fc1u, fc1v, fc1w, fc2u, fc2v, fc2w of each phase of the first and second inverters 22, 24. The setting is performed based on the element temperatures αi1u, αi1v, αi1w, αi2u, αi2v, αi2w of each phase of each of the first and second inverters 22, 24 from the temperature maximum value selection unit 74. The carrier frequency is a frequency of a carrier wave (triangle wave) used for comparison with the above-described duty factor command (modulated wave) when the PWM signal of each transistor is generated. For example, the element temperature αi is applied to a carrier frequency setting map determined in advance by an experiment, analysis, or the like, as a relationship between the element temperatures αi1u, αi1v, αi1w, αi2u, αi2v, αi2w (referred to as the element temperature ai as a whole) and the carrier frequencies fc1u, fc1v, fc1w, fc2u, fc2v, fc2w (referred to as the carrier frequency fc as a whole). Then, the corresponding carrier frequency fc is derived from the map. FIG. 3 is an explanatory diagram showing an example of a carrier frequency setting map. As shown in the figure, in a region where the element temperature αi is equal to or lower than the threshold value αilo, the value fchi is set to the carrier frequency fc. In addition, in a region where the element temperature αi is higher than the threshold value αilo and lower than a higher threshold value aihi, the carrier frequency fc is set to be gradually lower from a value fchi as the element temperature ai becomes higher to a value fclo lower than the value fchi. Further, in a region where the element temperature αi is equal to or higher than a threshold value αihi, the value fclo is set to the carrier frequency fc. That is, the carrier frequencies fc1u, fc1v, fc1w, fc2u, fc2v, fc2w are set for setting the PWM signals of the transistors. The carrier frequencies fc1u, fc1v, fc1w, fc2u, fc2v, fc2w are set to be lower as the element temperatures αi1u, αi1v, αi1w, αi2u, αi2v, αi2w are higher, respectively.

The PWM conversion unit 76 generates PWM signals S11 to S16, S21 to S26 of the transistors T11 to T16, T21 to T26. For the generation of the PWM signal, the duty command Du*, Dv*, Dw* of each phase from the dq-uvw conversion unit 73 and the carrier frequencies fc1u, fc1v, fc1w, fc2u, fc2v, fc2w of each phase from the carrier frequency setting unit 75 are used. Specifically, the PWM signals S11, S14 of the transistors T11, T14 are generated by using the comparison result between the duty command Du* of the U phase and the carrier frequency fc1u (triangle wave). Further, the PWM signals S21, S24 of the transistors T21, T24 are generated by using comparison between the duty command Du* and the carrier frequency fc2u. In addition, the PWM signals S12, S15 of the transistors T12, T15 are generated by using the comparison result between the duty command Dv* of the V phase and the carrier frequency fc1v of the carrier wave (triangle wave). In addition, the PWM signals S22, S25 of the transistors T22, T25 are generated by using comparison between the duty command Dv* and the carrier frequency fc2v. PWM signals S13, S16 of transistors T13, T16 are generated using a comparison result between the duty command Dw* of the W phase and the carrier wave (triangle wave) of the carrier frequency fclw. In addition, the PWM signals S23, S26 of the transistors T23, T26 are generated by using comparison between the duty command Dw* and the carrier frequency fc2w. In this way, when the PWM signals S11 to S16, S21 to S26 of the transistors T11 to T16, T21 to T26 are generated, the switching control of the transistors T11 to T16, T21 to T26 is performed using the PWM signals. As described above, the carrier frequency fc is set to be lower as the element temperature ai is higher. For example, the carrier frequency fc1u is set to be lower as the element temperature αiu1 is higher for the U phase of the first inverter 22. Therefore, for the U phase of the first inverter 22, when the element temperature αiu1 is low, the control performance of the U phase can be improved by increasing the carrier frequency fc1u. When the element temperature αiu1 is high, the element temperature αiu1 can be further suppressed from increasing by reducing the carrier frequency fc1u. The same applies to the V phase and the W phase of the first inverter 22 and the U phase, the V phase, and the W phase of the second inverter 24.

Even when the carrier frequencies fc1u, fc1v, fc1w, fc2u, fc2v, fc2w of each phase of the first and second inverters 22, 24 are made constant, the element temperatures αi1u, αi1v, αi1w, ai2u, ai2v, ai2w may vary. This is caused by manufacturing variations (variations in heat generation characteristics) of the transistors T11 to T16, T21 to T26 of the first and second inverters 22, 24. Based on the above, in the embodiment, the carrier frequencies fc1u, fc1v, fc1w, fc2u, fc2v, fc2w are set as follows for each phase of each of the first and second inverters 22, 24. The carrier frequencies fc1u, fc1v, fc1w, fc2u, fc2v, fc2w are lower as the element temperatures αi1u, αi1v, αi1w, ai2u, ai2v, ai2w are higher. As a result, it is possible to suppress the temperature of a specific transistor among the transistors T11 to T16, T21 to T26 of the first and second inverters 22, 24 from being excessively high. As a result, it is possible to suppress the occurrence of an event that the temperature of a specific transistor is excessively high and the output of the motor 18 needs to be limited for protecting the component.

In the power conversion apparatus 20 mounted on the battery electric vehicle 10 of the embodiment described above, the PWM signals of the transistors T11 to T16, T21 to T26 of the first and second inverters 22, 24 are generated by using the duty commands Du*, Dv*, Dw* of the respective phases based on the torque command Tm* of the motor 18 and the carrier waves. The power conversion apparatus 20 controls the first and second inverters 22, 24. In this case, for each phase of the first and second inverters 22, 24, the carrier frequencies fc1u, fc1v, fc1w, fc2u, fc2v, fc2w are set as follows. The carrier frequencies fc1u, fc1v, fc1w, fc2u, fc2v, fc2w are lower as the element temperatures αi1u, αi1v, αi1w, ai2u, ai2v, ai2w are higher. As a result, it is possible to suppress the temperature of a specific transistor among the transistors T11 to T16, T21 to T26 of the first and second inverters 22, 24 from being excessively high.

In the above-described embodiment, the carrier frequency setting unit 75 sets the carrier frequencies fc1u, fc1v, fc1w, fc2u, fc2v, fc2w such that the carrier frequencies fc1u, fc1v, fclw, fc2u, fc2v, fc2w become lower as the element temperatures αi1u, αi1v, αi1w, ai2u, ai2v, ai2w become higher for each phase of the first and second inverters 22, 24. However, the elements of the disclosure are not limited to this.

For example, when the motor 18 is in the lock state, the current concentration phase may be specified based on the electrical angle de of the motor 18, and the carrier frequency of the current concentration phase may be set to be lower than that when the motor 18 is not in the lock state. The lock state of the motor 18 is detected, for example, when a condition that the absolute value of the rotation speed Nm of the motor 18 is equal to or less than a threshold value Nmref and the absolute value of the torque command Tm* of the motor 18 is equal to or greater than a threshold value Tmref is satisfied. When the motor 18 is in the lock state, a current having a large absolute value flows in the current concentration phase according to the electrical angle θe of the motor 18, and the element temperature of the current concentration phase is likely to be higher than the element temperature of the other phases. Therefore, by setting the carrier frequency of the current concentration phase to be lower than the carrier frequency when the motor 18 is not in the lock state, it is possible to suppress the temperature of a specific transistor among the transistors T11 to T16, T21 to T26 from being excessively high. The transistors T11 to T16, T21 to T26 are transistors of the first and second inverters 22, 24.

In addition, for each phase of the first and second inverters 22, 24, the carrier frequencies fc1u, fc2u, fc1v, fc2v, fc1w, fc2w may be set such that the larger the integrated values Iusum, Ivsum, Iwsum, the lower the carrier frequencies fc1u, fc2u, fc1v, fc2v, fc1w, fc2w. The integrated values Iusum, Ivsum, Iwsum are integrated values of absolute values of the phase currents Iu, Iv, Iw at a predetermined time. It is assumed that the higher the integrated values Iusum, Ivsum, Iwsum are, the higher the element temperatures αi1u, αi2u, αi1v, αi2v, αi1w, αi2w are. Therefore, the carrier frequencies fc1u, fc2u, fc1v, fc2v, fc1w, fc2w are set to be lower as the integrated values Iusum, Ivsum, Iwsum are larger. As described above, by setting the carrier frequencies fc1u, fc2u, fc1v, fc2v, fc1w, fc2w, the temperature of a specific transistor among the transistors T11 to T16, T21 to T26 of the first and second inverters 22, 24 can be suppressed from being excessively high.

In the above-described embodiment, the power conversion apparatus 20 mounted on the battery electric vehicle 10 includes the first and second capacitors 30, 32, but is not limited thereto. For example, the second capacitor 32 may not be provided.

In the above-described embodiment, the power conversion apparatus 20 mounted on the battery electric vehicle 10 is provided with the switching switches 34p, 34n, but is not limited thereto. For example, at least one of the switching switches 34p, 34n may not be provided.

In the above-described embodiment, the power conversion apparatus 20 is mounted on the battery electric vehicle 10 including the motor 18, but the present disclosure is not limited thereto. For example, the power conversion apparatus may be mounted on a hybrid electric vehicle that is provided with an engine in addition to the same hardware configuration as the battery electric vehicle 10. Further, the power conversion apparatus may be mounted on a fuel cell electric vehicle that is provided with a fuel cell in addition to the same hardware configuration as the battery electric vehicle 10.

The correspondence between the main elements of the embodiment and the main elements of the disclosure described in the column of the means for solving the problems will be described. In the embodiment, the battery 12 corresponds to the “power storage device”, the motor 18 corresponds to the “motor”, and the electric power conversion apparatus 20 corresponds to the “electric power conversion apparatus”. The first inverter 22 corresponds to the “first inverter”, the second inverter 24 corresponds to the “second inverter”, and the ECU 50 corresponds to the “control device”.

The correspondence between the main elements of the embodiment and the main elements of the disclosure described in the column of means for solving the problem is an example for specifically describing the embodiment for implementing the disclosure described in the column of means for solving the problem. Therefore, the elements of the disclosure described in the column of the means for solving the problem are not limited. That is, the interpretation of the disclosure described in the column of the means for solving the problem should be made based on the description in the column, and the embodiment is merely a specific example of the disclosure described in the column of the means for solving the problem.

Although the embodiment for implementing the above-described disclosure has been described, the above-described disclosure is not limited to the embodiment, and can be implemented in various forms within the scope of the spirit of the above-described disclosure.

The present disclosure can be used in a manufacturing industry of a power conversion apparatus or the like.

What is claimed is:

1. A power conversion apparatus connected to a power storage device and a motor having a three-phase open winding, the power conversion apparatus comprising:
a first inverter connected to a power line to which the power storage device is connected, and connected to a first end side of the three-phase open winding;
a second inverter connected to the power line, and connected to a second end side of the three-phase open winding; and
a control device configured to generate PWM signals of a plurality of switching elements of the first and second inverters by using a modulated wave and a carrier wave of each phase, and to control the first and second inverters, the modulated wave being based on a torque command of the motor,
wherein the control device is configured to vary a carrier frequency of the carrier wave for each phase of the first and second inverters based on a variation in an element temperature of each of the switching elements of the first and second inverters.

2. The power conversion apparatus according to claim 1, wherein the control device is configured to set the carrier frequency for each phase of the first and second inverters such that the carrier frequency is lower as the element temperature is higher.

3. The power conversion apparatus according to claim 1, wherein the control device is configured to, in a case where the motor is in a lock state, lower the carrier frequency of a current concentration phase based on an electrical angle of the motor as compared to a case where the motor is not in the lock state.

4. The power conversion apparatus according to claim 1, wherein the control device is configured to set the carrier frequency for each phase of the first and second inverters such that the carrier frequency is lower as an integrated value of an absolute value of a phase current in a predetermined time is larger.
